(19) United States
(12) Patent Application Publication
(10) Pub. No.: US 2021/0054976 A1
(43) Pub. Date: Feb. 25, 2021

(54) REALISTIC CANDLE LIGHTING DECORATION

(71) Applicant: JACQUES ROUSSON, Kemptville (CA)

(72) Inventor: JACQUES ROUSSON, Kemptville (CA)

(21) Appl. No.: 16/993,703

(22) Filed: Aug. 14, 2020

Related U.S. Application Data
(60) Provisional application No. 62/889,601, filed on Aug. 21, 2019.

(51) Int. Cl. F21S 6/00; F21S 9/02

(52) U.S. Cl. CPC F21S 6/001; F21W 2121/00; F21S 9/02

(57) ABSTRACT

Described herein is a realistic candle lighting decoration assembly. The assembly including a base portion with a socket in a coupling with a power source. The power source selected from either direct current or alternating current. The assembly including a stem portion with the stem portion having a first end with a contact portion having a size and shape configured for receipt in the socket in a coupling with the power source. The stem portion including an interior with a lighting element and movable flame portion configured to resemble a traditional wax candle assembly.

### CROSS-REFERENCE TO RELATED APPLICATION

This U.S. patent application claims priority to U.S. Provisional Application: Application No. 62/889,601 filed Aug. 21, 2019, the disclosure of which is considered part of the disclosure of this application and is hereby incorporated by reference in its entirety.

### FEDERALLY SPONSORED RESEARCH OR DEVELOPMENT

Not Applicable

### SEQUENCE LISTING, A TABLE, OR A COMPUTER PROGRAM

Not Applicable

### FIELD OF THE INVENTION

The invention relates generally to a lighting decoration configured with a shape and structure to resemble a realistic candle placed within a traditional candle holder. More particularly, the device of the present disclosure provides a lighting device with a base portion having a removable lighted element with a flickering light assembly.

### BACKGROUND

Holiday decorations have long utilized illuminated lighting implements to brighten and highlight the myriad of displays and dioramas. Traditionally, these decorations were in the form of candles. Candle provide a desirable aesthetic and also a natural flickering light. Although the aesthetic is desirable and provides pleasant illumination it is also very dangerous as it exposes additional and potentially flammable surfaces to an open flame.

Accordingly, one of the more ubiquitous decorations around Holiday time has become the safer option in the form of the string light. This standard string light most generally comprises a wired base portion with a removable bulb. These string lights typically utilize universal bulb sizes and types ranging from mini lights, to C6, C7, C9, and G12 bulb types. Although generally useful, these lighting elements generally lack additional features in the form of powered lighted element that resembles the flickering illumination of a traditional candle. Further, these universal bulb types are generally provided in a bulb and a socket connection that either uses a threaded connection or press fit connection to complete a contact with a power source.

Therefore, there exists a need within the marketplace for an improved lighting decoration that combines the elements of a candle aesthetic with flickering light in a safe and adaptable and flexible assembly. Preferably this assembly is configured for use with both alternating current (AC) and direct current (DC) and includes a base portion configured for the removable placement of alternate lighted elements in a variety of colors, shapes, and sizes.

### SUMMARY OF THE INVENTION

The present disclosure is most generally directed to an improved decorative lighting fixture that is configured to resemble a realistic candle when illuminated during use. The device is configured with a base portion having a socket sized and shaped for the receipt of a stem portion. The base portion including a power source, including both features for alternating and direct current to provide current to a lighting element, such as, but not limited to, a bulb, element, light emitting diode, or filament that is placed within an interior of the stem portion.

The base portion having a shape configured to resemble a traditional candle holder including a tray portion with a generally flattened profile and extending around an entire circumference of the base portion. The base portion further having a lower side opposite an upper side, with the lower side having a clip. The clip being removable and including a spring member to create tension to enable the clip to secure the base portion to a variety of surfaces during use.

The stem portion having a generally cylindrical shape selected to resemble a traditional candle. The stem portion having a first end and a second end opposed the first end. The first end including a contact portion configured for a coupling within the socket of the base portion to enable illumination of the lighting element. The second end of the stem portion including a central aperture for the receipt of a movable flame portion, the movable flame portion generally hingedly coupled within the aperture and configured to move and flicker during use, wherein the movable flame portion is generally constructed out of a light weight and reflective material.

In an additional embodiment of the present disclosure, the base portion includes an annular ring surrounding the socket and on an exterior of the upper side. The annular ring configured with a size and shape configured to form a groove for the receipt of a weather shield. The weather shield generally comprised of a translucent material and configured to surround and protect the stem portion. The weather shield adapted to mimic a traditional candle surround that would be utilized to protect a flame from exposure to wind.

The invention now will be described more fully hereinafter with reference to the accompanying drawings, which are intended to be read in conjunction with both this summary, the detailed description and any preferred and/or particular embodiments specifically discussed or otherwise disclosed. This invention may, however, be embodied in many different forms and should not be construed as limited to the embodiments set forth herein; rather, these embodiments are provided by way of illustration only and so that this disclosure will be thorough, complete and will fully convey the full scope of the invention to those skilled in the art.

### BRIEF DESCRIPTION OF THE DRAWINGS

FIG. 1 shows the front view of the device, according to the present disclosure;

FIG. 2 shows the front view of the device with the clip removed, according to the present disclosure;

FIG. 3 shows the right side view of the device, according to the present disclosure;

FIG. 4 shows the left side view of the device, according to the present disclosure;

FIG. 5 shows the bottom side view of the device, according to the present disclosure;

FIG. 6 shows the top side view of the device, according to the present disclosure;

FIG. 7 shows the top side view of the base of the device with stem portion removed, according to the present disclosure;

FIG. 8 shows the isometric view of the device, according to the present disclosure;

FIG. 9 shows the perspective view of the stem portion without the base portion, according to the present disclosure;

FIG. 10 shows the isometric view of the base portion of the device, according to the present disclosure;

FIG. 11 shows an isometric view of the removable clip, according to the present disclosure;

FIG. 12 shows an isometric view of the device with a weather shield installed, according to the present disclosure;

FIG. 13 shows the front side view of device with cords in an alternating current powered version, according to the present disclosure; and

FIG. 14 shows the perspective view of multiple devices provided with a cord, according to the present disclosure.

### DETAILED DESCRIPTION OF THE INVENTION

The following detailed description includes references to the accompanying figures, which form a part of the detailed description. The figures show, by way of illustration, specific embodiments in which the invention may be practiced. These embodiments, which are also referred to herein as “examples,” are described in enough detail to enable those skilled in the art to practice the invention. The embodiments may be combined, other embodiments may be utilized, or structural, and logical changes may be made without departing from the scope of the present invention. The following detailed description is, therefore, not to be taken in a limiting sense.

Before the present invention is described in such detail, however, it is to be understood that this invention is not limited to particular variations set forth and may, of course, vary. Various changes may be made to the invention described and equivalents may be substituted without departing from the true spirit and scope of the invention. In addition, many modifications may be made to adapt a particular situation, material, composition of matter, process, process act(s) or step(s), to the objective(s), spirit or scope of the present invention. All such modifications are intended to be within the scope of the disclosure made herein.

Unless otherwise indicated, the words and phrases presented in this document have their ordinary meanings to one of skill in the art. Such ordinary meanings can be obtained by reference to their use in the art and by reference to general and scientific dictionaries.

References in the specification to “one embodiment” indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The following explanations of certain terms are meant to be illustrative rather than exhaustive. These terms have their ordinary meanings given by usage in the art and in addition include the following explanations.

As used herein, the term “and/or” refers to any one of the items, any combination of the items, or all of the items with which this term is associated.

As used herein, the singular forms “a,” “an,” and “the” include plural reference unless the context clearly dictates otherwise.

As used herein, the terms “include,” “for example,” “such as,” and the like are used illustratively and are not intended to limit the present invention.

As used herein, the terms “preferred” and “preferably” refer to embodiments of the invention that may afford certain benefits, under certain circumstances. However, other embodiments may also be preferred, under the same or other circumstances.

Furthermore, the recitation of one or more preferred embodiments does not imply that other embodiments are not useful and is not intended to exclude other embodiments from the scope of the invention.

As used herein, the term “coupled” means the joining of two members directly or indirectly to one another. Such joining may be stationary in nature or movable in nature and/or such joining may allow for the flow of fluids, electricity, electrical signals, or other types of signals or communication between two members. Such joining may be achieved with the two members or the two members and any additional intermediate members being integrally formed as a single unitary body with one another or with the two members or the two members and any additional intermediate members being attached to one another. Such joining may be permanent in nature or alternatively may be removable or releasable in nature.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element without departing from the teachings of the disclosure.

The invention of the present disclosure is most generally configured as an improved lighting assembly adapted to resemble a realistic candle.

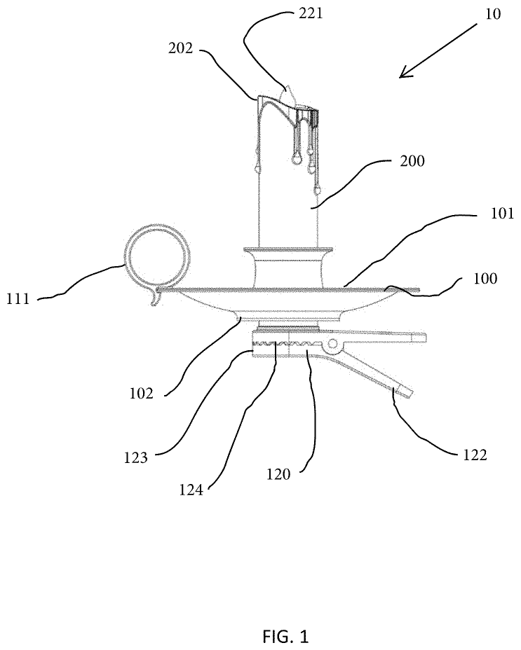

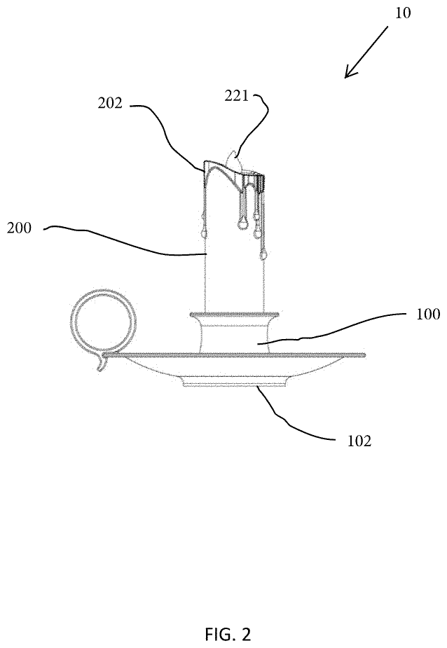

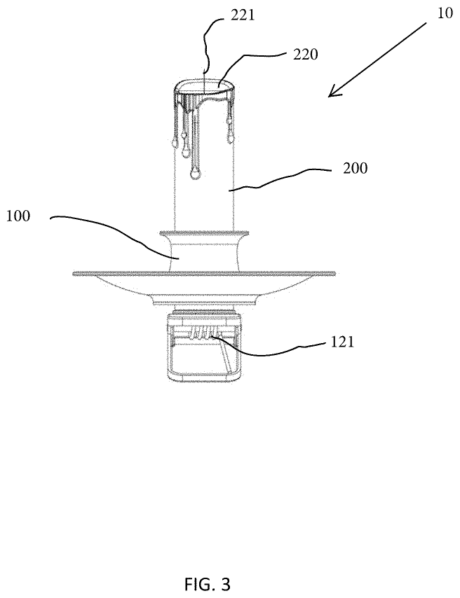

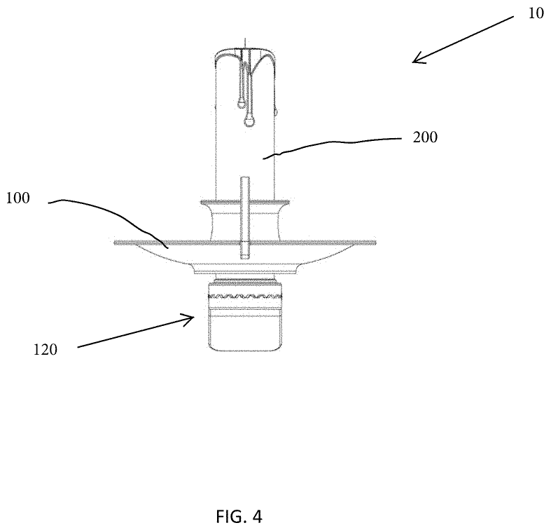

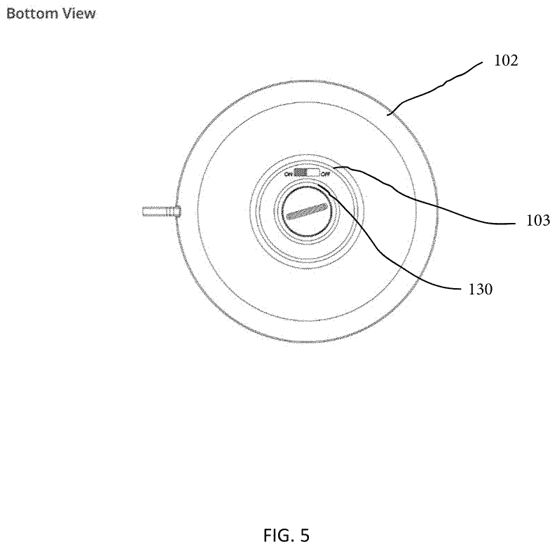

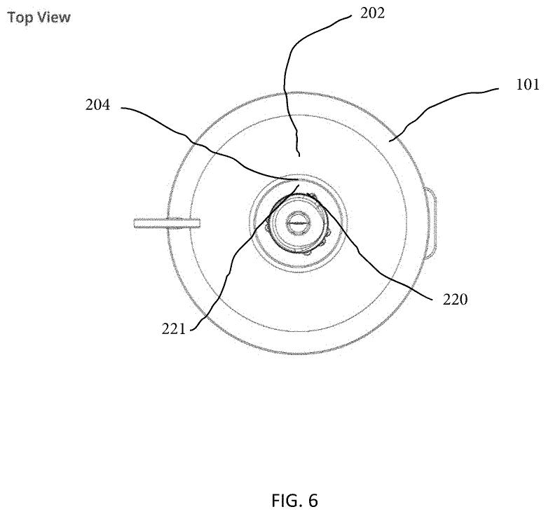

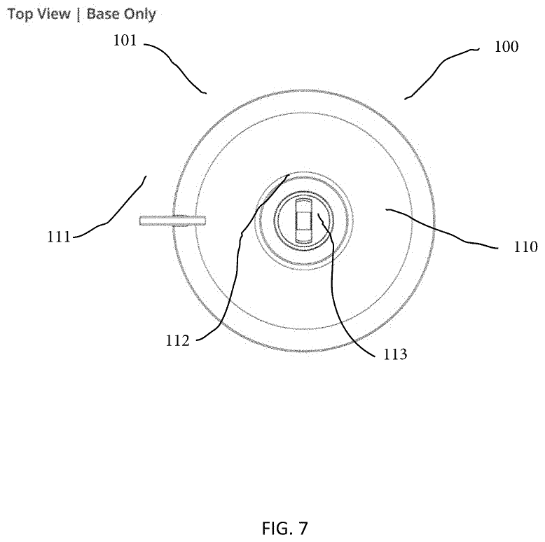

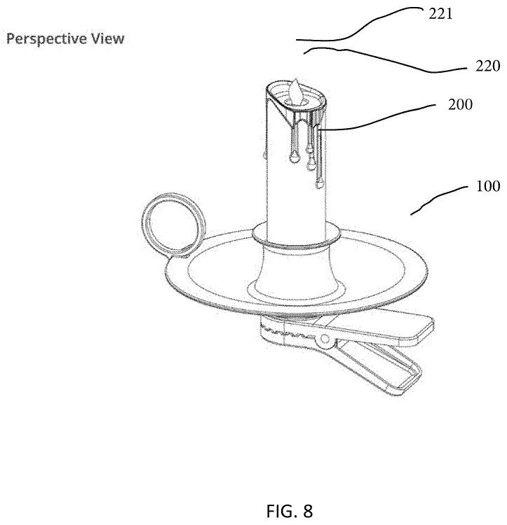

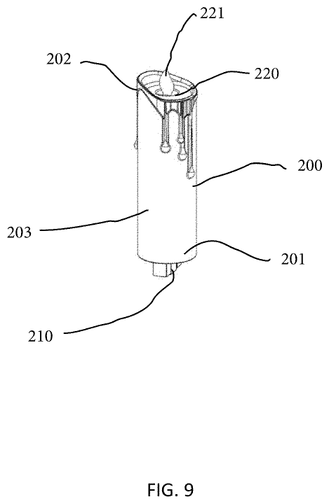

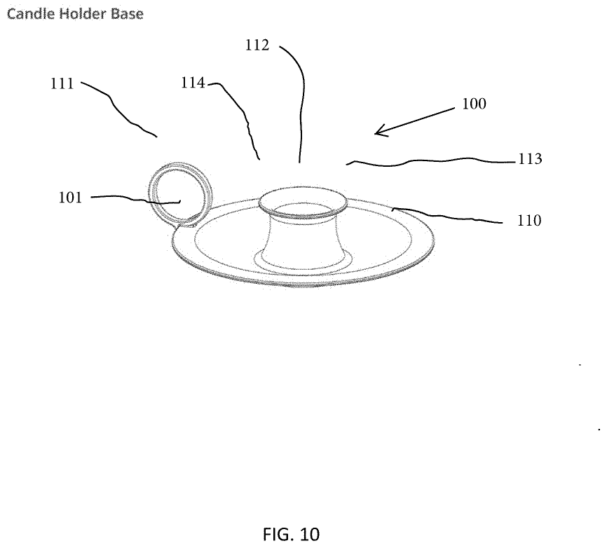

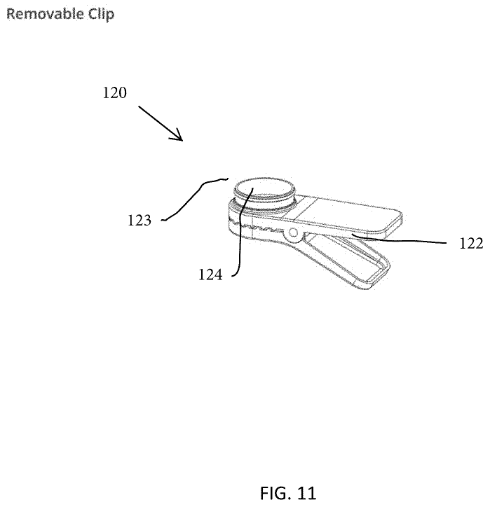

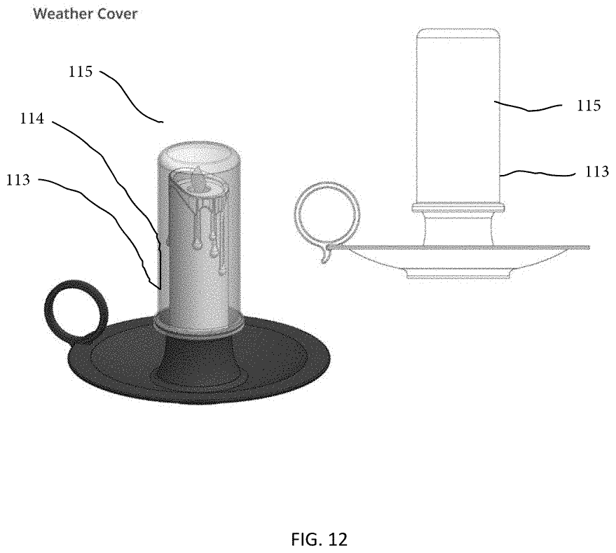

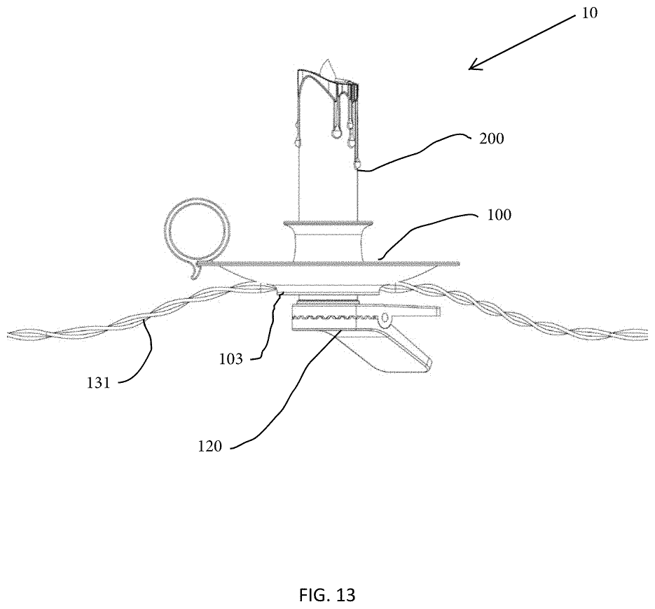

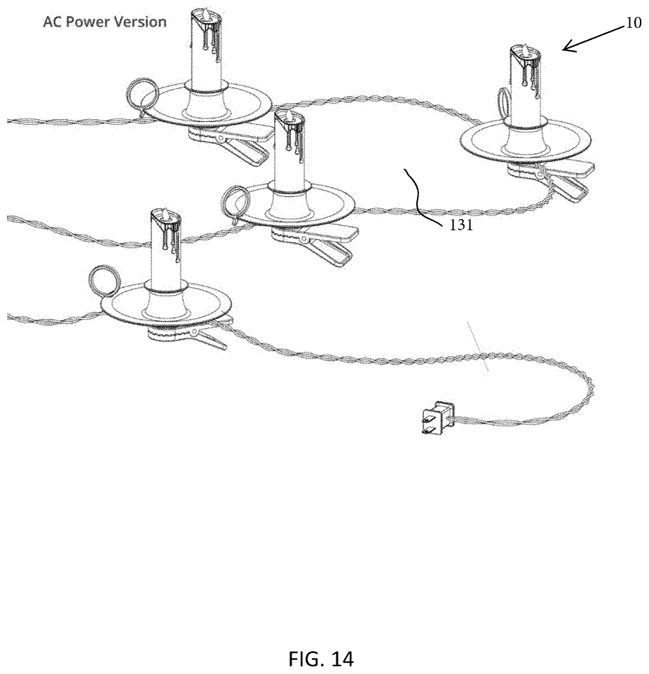

Referring now to the figures, FIGS. 1-14 show a lighting decoration configured to resemble a realistic candle according to the present disclosure and generally referred to herein as device 10. The device 10 is most generally provided in a structural assembly with a base portion 100 and a stem portion 200, resembling a candle and configured for removable receipt into the base portion 100.

The base portion 100 having an upper side 101 and a lower side 102 opposed the upper side 101. The base portion 100 generally having a shape configured to resemble a traditional candle holder including a tray portion 110 with a substantially flattened profile and extending around an entire circumference of the base portion 100. The base portion including a handle 111 generally providing an aperture for grasping and configured to aid in handling the device 10 during use. The upper side 101 including a socket 112 sized and shaped for the receipt of the stem portion 200 in a coupling.

The base portion 100 including a power source 103. The power source 103 configured to provide power to the socket 112 in the form of a current for generally illuminating a lighting element 203 within the stem portion 200. In a first embodiment of the present disclosure, the power source 103 is a battery 130 to provide direct current (DC) to the socket 112. The battery 130 is preferably a button cell type of battery or watch battery as it commonly referred. This type of battery 130 is preferred for its flattened and cylindrical profile for receipt within the base portion 100. Although a button cell battery 130 is preferred, other types and sizes of batteries may be utilized without departure from the spirit of the present invention. In an alternate embodiment of the present disclosure, the power source 103 is an alternating current (AC), wherein the power source 103 is a standard electrical outlet in a coupling with the base portion 100 through a cord 131. In yet another alternate embodiment, the device 10 base portion 100 can be configured for use with either the battery 130 or the cord 131 as the power source 103.

The base portion 100 lower side 102 having a clip 120. The clip 120 configured for receipt on the lower side 102 in a removable assembly, wherein the clip 120 may be easily removed and not used on the device 10. The clip 120 configured with a tensioning member 121, such as, but not limited to, a resilient member, such as a torsion spring, adapted to be biased to provide a clamping and grasping force to a surface the device 10 may be affixed to. Accordingly, the clip 120 includes a handle portion 122 and clamp portion 123. The clamp portion 123 may include serrations 124 to enable better holding and increasing the surface area of the clap portion 123 during use.

The stem portion 200 having a generally cylindrical shape selected to resemble a traditional candle with a first end 201 opposed a second end 202, with the distance between the first end 201 and the second end 202 defining a height of the stem portion 200. The first end 201 including a contact portion 210 configured for an electric coupling within the socket 112 of the base portion 100 to enable illumination of the lighting element 203. The lighting element 203 generally capable of illumination and provided in assembly, including, but not limited to a bulb, element, light emitting diode, or filament that is placed within an interior 204 of the stem portion 200.

The second end 202 of the stem portion 200 including a central aperture 220 for the receipt of a movable flame portion 221, the movable flame portion 221 generally hingedly coupled within the aperture 220 and configured to move and flicker during use of the device 10. Accordingly, the movable flame portion 221 is positioned above the lighting element 203, wherein the lighting element 203 illumination is reflected upon the movable flame portion 221. In the preferred embodiment of the present disclosure, this movable flame portion 221 is generally constructed out of a light weight and reflective material. In the preferred assembly of the present disclosure, this movable flame portion 221 is configured to tilt, shimmer, shake, and tip due to heat from the lighting element 203 or ambient air flow.

In an additional embodiment of the present disclosure, the base portion 100 includes an annular ring 113 surrounding the socket 112 and on an exterior of the upper side 101 tray portion 110. The annular ring 113 configured with a size and shape and forming a groove 114 for the receipt of a weather shield 115. The weather shield 115 generally comprised of a translucent material and configured to surround and protect the entire height of the stem portion 200. The weather shield 115 adapted to mimic a traditional candle surround that would be utilized to protect a flame from exposure to wind and the elements.

Most generally the device 10 is configured to resemble a traditional wax candle aesthetic with a synthetic flickering flame. Accordingly, the device 10 of the present disclosure may be offered in multiple colors and aesthetics.

While the invention has been described above in terms of specific embodiments, it is to be understood that the invention is not limited to these disclosed embodiments. Upon reading the teachings of this disclosure many modifications and other embodiments of the invention will come to mind of those skilled in the art to which this invention pertains, and which are intended to be and are covered by both this disclosure and the appended claims. It is indeed intended that the scope of the invention should be determined by proper interpretation and construction of the appended claims and their legal equivalents, as understood by those of skill in the art relying upon the disclosure in this specification and the attached drawings.

1. A lighting decoration, the lighting decoration comprising:
a base portion, the base portion comprising:
an upper side, the upper side including a socket, the socket coupled to a power source; and
a lower side, the lower side opposed the upper side; and
a stem portion, the stem portion resembling a candle and comprising:
a first end, the first end having a contact portion, the contact portion configured for receipt and coupling in the socket with the power source;
a second end, the second end opposite the first end, the second end including an aperture, the aperture sized for the receipt of a movable flame portion; and
an interior portion, the interior portion including a lighting element, the lighting element coupled to the contact portion, wherein the lighting element illuminates the movable flame portion.

2. The lighting decoration as in claim 1, wherein the base portion lower side includes a removable clip.

3. The lighting decoration as in claim 2, wherein the removable clip includes a resilient member configured to provide grasping tension to the clip, wherein the removable clip affixes the decoration to a surface.

4. The lighting decoration as in claim 1, wherein the power source is a battery.

5. The lighting decoration as in claim 1, wherein the power source is a plug configured for receipt in a standard electrical receptacle.

6. The lighting decoration as in claim 1, wherein the base portion upper side includes an annular ring, the annular ring surrounding the socket and configured for the receipt of a weather shield, the weather shield having a size to surround the stem portion.

7. The lighting decoration as in claim 6, wherein the weather shield is translucent.

8. A decorative lighting assembly, the lighting assembly comprising:
a base portion, the base portion comprising:
an upper side, the upper side generally forming a tray portion and including a socket, the socket coupled to a power source; and
a lower side, the lower side opposed the upper side, the lower side including a removable clip; and
a stem portion, the stem portion resembling a candle and comprising:
a first end, the first end having a contact portion, the contact portion configured for receipt in the socket and coupling with the power source;
a second end, the second end opposite the first end, the second end including an aperture, the aperture sized for the receipt of a movable flame portion; and
an interior portion, the interior portion including a lighting element, the lighting element coupled to the contact portion, wherein the lighting element illuminates the movable flame portion.

9. The decorative lighting assembly as in claim 8, wherein the removable clip includes a resilient member configured to provide grasping tension to the clip, wherein the removable clip affixes the assembly to a surface.

10. The decorative lighting assembly as in claim 8, wherein the power source is a battery.

11. The decorative lighting assembly as in claim 8, wherein the power source is a plug configured for receipt in a standard electrical receptacle.

12. The decorative lighting assembly as in claim 8, wherein the base portion upper side includes an annular ring, the annular ring surrounding the socket and configured for the receipt of a weather shield, the weather shield having a size to surround the stem portion.

13. The decorative lighting assembly as in claim 12, wherein the weather shield is translucent.

14. The decorative lighting assembly as in claim 8, wherein the base portion includes a handle, the handle having an aperture and configured for use in grasping the assembly.

15. A lighting assembly configured to resemble a traditional candle, the lighting assembly comprising:
a base portion, the base portion comprising:
an upper side, the upper side generally forming a tray portion and including a socket, the socket coupled to a power source; and
a lower side, the lower side opposed the upper side, the lower side including a removable clip; and
a stem portion, the stem portion resembling a wax candle and comprising:
a first end, the first end having a contact portion, the contact portion configured for receipt in the socket and coupling with the power source;
a second end, the second end opposite the first end, the second end including an aperture, the aperture sized for the receipt of a movable flame portion, wherein the movable flame portion flickers during use; and
an interior portion, the interior portion including a lighting element, the lighting element coupled to the contact portion, wherein the lighting element illuminates the movable flame portion.

16. The lighting assembly as in claim 15, wherein the removable clip includes a resilient member configured to provide grasping tension to the clip, wherein the removable clip affixes the assembly to a surface.

17. The lighting assembly as in claim 15, wherein the power source is a battery.

18. The lighting assembly as in claim 15, wherein the power source is a plug configured for receipt in a standard electrical receptacle.

19. The lighting assembly as in claim 15, wherein the base portion upper side includes an annular ring, the annular ring surrounding the socket and configured for the receipt of a weather shield, the weather shield having a size to surround the stem portion.

20. The lighting assembly as in claim 15, wherein the base portion includes a handle, the handle having an aperture and configured for use in grasping the assembly.
